(19) United States
(12) Patent Application Publication
(10) Pub. No.: US 2007/0095547 A1
(43) Pub. Date: May 3, 2007

(54) Fire extinguishers

(75) Inventor: Peter Moore, Reading (GB)

Correspondence Address: MERCHANT & GOULD PC, P.O. BOX 2903, MINNEAPOLIS, MN, 55402-0903, US

(73) Assignee: Kidde IP Holdings Limited, Slough (GB)

(21) Appl. No.: 11/583,206

(22) Filed: Oct. 18, 2006

(30) Foreign Application Priority Data
Oct. 19, 2005 (GB) 0521285.7

(51) Int. Cl. A62C 11/00

(52) U.S. Cl. 169/30; 239/71; 239/289; 362/96; 42/114; 42/146

(57) ABSTRACT

A fire extinguisher (10) has a discharge member (12) for directing an extinguishing agent from the extinguisher (10) towards a target. The extinguisher (10) also has at least one light beam director (17, 18) for directing a beam of light (19, 20) in a predetermined direction relative to the discharge member (12) so that the discharge member (12) can be aimed at a target by directing the light beam (19, 20) at or adjacent to the target.

The invention relates to fire extinguishers. Preferably, but not exclusively, the fire extinguishers of the invention are portable.

Hand held fire extinguishers having a discharge member for directing an extinguishing agent from the extinguisher towards a target are well known. For example, in the case of a carbon dioxide fire extinguisher, the discharge member may be a conical horn which directs the carbon dioxide towards a fire. In the case of a water fire extinguisher, the discharge member may be nozzle, provided on a flexible hose, by which the water can be directed towards a fire.

Hitherto during operation of hand held fire extinguishers, the user simply points the discharge member towards the target fire. In some circumstances, it is desirable to be able to aim the discharge member towards the target fire in a more accurate manner.

In accordance with an aspect of the invention, there is provided a fire extinguisher having a discharge member for directing an extinguishing agent from the extinguisher towards a target, the extinguisher also having at least one light beam director for directing a beam of light in a predetermined direction relative to the discharge member so that the discharge member can be aimed at a target by directing the light beam at or adjacent to the target.

It can be even more important to give the user of a hand held fire extinguisher some indication of the correct distance to stand away from the fire to ensure maximum effectiveness of the fire extinguisher.

In accordance with a preferred embodiment of the invention, the fire extinguisher described above includes two light beam directors for directing respective light beams in respective predetermined directions relative to the discharge member so that the light beams substantially cross one another and so that the discharge member can be aimed at a target and positioned at a desired distance from the target by moving the discharge member so that the light beams substantially cross one another at or adjacent to the target.

The following is a more detailed description of embodiments of the invention, by way of example, reference being made to the appended schematic drawings in which:

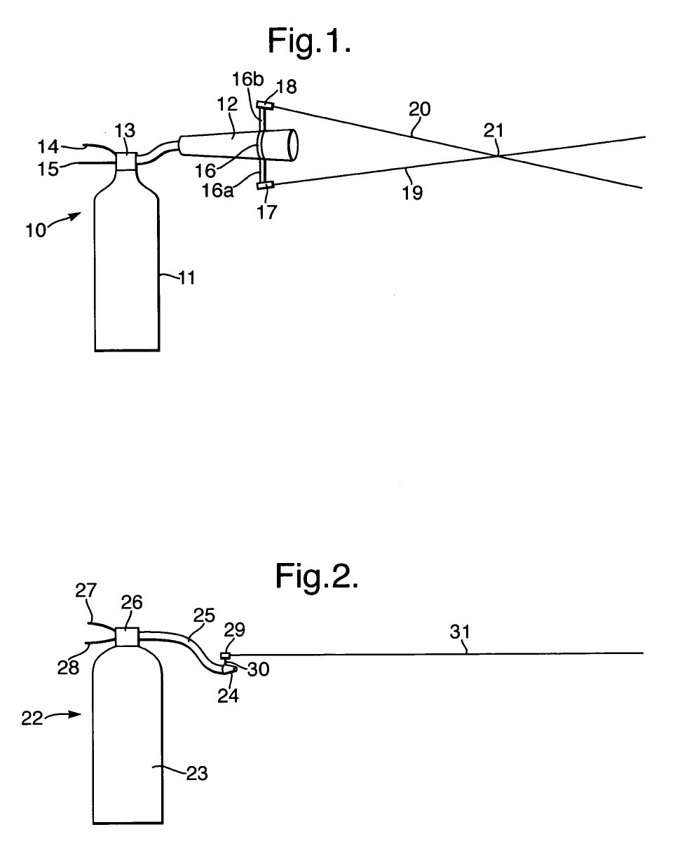

FIG. 1 is a representation of a first carbon dioxide fire extinguisher;

FIG. 2 is a representation of a first water fire extinguisher;

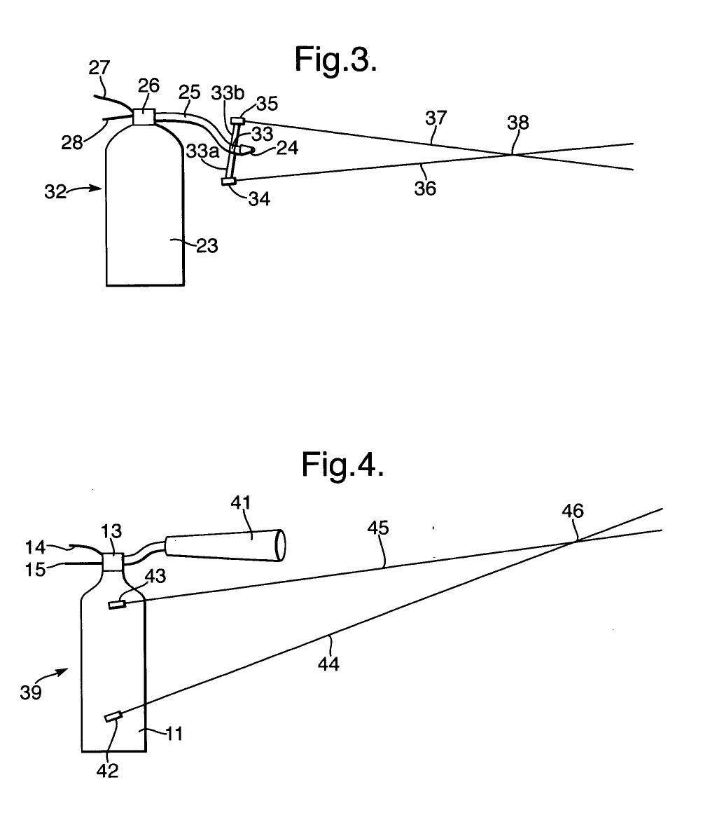

FIG. 3 is a representation of a second water fire extinguisher; and

FIG. 4 is a representation of a second carbon dioxide fire extinguisher.

Looking at FIG. 1, the first carbon dioxide fire extinguisher 10 comprises a main body 11, which holds the carbon dioxide extinguishing agent, a discharge member in the form of a discharge horn 12, a valve 13 and upper and lower handles 14, 15 which operate the valve 13. In a known manner, the discharge horn 12 is mounted for pivotal movement adjacent the valve 13 so that the angle of the discharge horn 12 relative to the main body 11 can be changed by manually moving the discharge horn 12.

The main body 11, the discharge horn 12, the valve 13 and the upper and lower handles 14, 15 are all well known.

A bracket 16 is fixedly mounted to the discharge horn 12. The bracket 16 has a first arm 16a which extends in a first direction away from the discharge horn 12, and a second arm 16b, which extends away from the discharge horn 12 in a second direction which is diametrically opposed to the first direction. A first LED laser diode 17 is fixedly mounted at the outer end of the first arm 16a of the bracket 16. A second LED laser diode 18 is fixedly mounted at the outer end of the second arm 16b of the bracket 16. Accordingly, as seen in FIG. 1, the first and second LED laser diodes 17, 18 are spaced from one another by a significant distance.

The first and second LED laser diodes 17, 18 are both connected in a simple electrical circuit (not shown) which also includes a battery (not shown) and a push button switch (not shown). Operation of the push button switch, which may be situated, for example, on the upper handle 14, closes the circuit so that the battery energises the LED laser diodes 17, 18 and causes the laser diodes 17, 18 to emit respective laser beams 19, 20.

As seen in FIG. 1, the first and second LED laser diodes 17, 18 are fixedly aligned so that they direct their respective laser beams 19, 20 so that the laser beams 19, 20 cross one another at an intersection point 21. The laser beams 19, 20 are directed in respective directions relative to the discharge horn 12 so that the intersection point 21 lies in line with the conical axis of the discharge horn 12 at a distance from the end of the discharge horn 12 which corresponds to the ideal distance for positioning the discharge horn 12 away from a fire in order to extinguish the fire with optimum effectiveness. When the extinguisher is operated the intersection or crossing point 21 lies in the middle of the stream of carbon dioxide.

In operation, after the carbon dioxide extinguisher 10 has been prepared for use (e.g. by removing the safety pin), the carbon dioxide extinguisher 10 is held approximately in the correct position relative to a fire to be extinguished. At this stage, the user presses the push button so as to energise the LED laser diodes 17, 18 which generate and direct the two laser beams 19, 20. If, for example, the source of the fire is an item of electrical equipment, the user moves the fire extinguisher 10 (thereby moving the discharge horn 12 and LED laser diode 17, 18) until both laser beams 19, 20 are visible on the item of electrical equipment. The beams will be visible as small dots of light. The user then moves the fire extinguisher 10 backwards or forwards so that the two dots corresponding to the two laser beams 19, 20 converge. At this stage, the intersection point 21 lies on the item of electrical equipment which is burning. The user then operates the upper and lower handles 14, 15 so as to operate the fire extinguisher 10 in the usual way. Carbon dioxide from the main body 11 is discharged through the discharge horn 12 towards the item of electrical equipment. By moving the fire extinguisher 10 so that the laser beams 19, 20 cross at the item of electrical equipment, the user ensures that the discharge horn 12 is both aimed accurately at the electrical item, and is also positioned at the ideal distance away from the electrical item. This may help to-improve the effectiveness with which the fire extinguisher 10 extinguishes the fire.

In FIG. 2, a water fire extinguisher 22 has a main body 23, which contains the water extinguishing agent, a discharge member 24 in the form of a nozzle, a flexible hose 25 which connects the nozzle 24 to the main body 23, a valve 26 and upper and lower handles 27, 28. The structure and operation of the components of the water fire extinguisher 22 described so far are well known.

A single LED laser diode 29 is connected to the discharge nozzle 24 by a bracket 30. The LED laser diode is connected in a simple electrical circuit (not shown) containing a battery (not shown) and a push button switch (not shown) as for the carbon dioxide fire extinguisher 10 shown in FIG. 1. When the push button switch is operated, the circuit is closed and the battery energises the LED laser diode 29 to produce a laser beam 31. The LED laser diode 29 directs the laser beam 31 so that the laser beam 31 lies generally parallel and close to the stream of water discharged from the nozzle 24.

In operation, after the water fire extinguisher 22 has been prepared for use, the push button is pressed so as to energise the LED laser diode 29 so as to produce the laser beam 31. The discharge nozzle 24 is then moved, which is possible without movement of the main body 23 by virtue of the flexible hose 25, so that the laser beam 31 is visible as a small dot at the location where the water is desired to extinguish the fire. The valve 26 is then operated via the handles 27, 28, in the usual manner, so that the water is expelled through the flexible hose 25 and the discharge nozzle 24 towards the fire. The stream of water hits the fire at the place where the laser beam dot was positioned. In this way, the water is accurately aimed at the required position.

It will be appreciated that, although the LED laser diode 29 allows the discharge nozzle 24 to be aimed more accurately at the fire, this system does not give the user any information about the preferred distance from the fire, as there is only a single laser beam 31.

FIG. 3 shows a second water fire extinguisher 32 which is similar to the water fire extinguisher 22 shown in FIG. 2. For convenience, features of the second water fire extinguisher 32 which are identical to the corresponding features of the first water fire extinguisher 22 are given the same reference numerals and are not described in detail.

The second water fire extinguisher 32 has a bracket 33 which is mounted on the flexible hose 25 adjacent to and spatially fixed relative to the discharge nozzle 24. The bracket 33 has a first arm 33a and a second arm 33b—the first and second arms 33a, 33b extending away from one another in diametrically opposed directions from the hose 25. A first LED laser diode 34 is fixedly mounted on the outer end of the first arm 33a and a second LED laser diode 35 is fixedly mounted on the outer end of the second arm 33b.

As for the previous embodiments, the first and second LED laser diodes 34, 35 are connected in a circuit (not shown) also including a battery (not shown) and a push button switch (not shown), so that operation of the switch causes the battery to energise the LED laser diodes 34, 35 so that they emit respective laser beams 36, 37.

As shown in FIG. 3, the first and second LED laser diodes 34, 35 are fixed relative to one another so that the laser beams 36, 37 cross one another at a point of intersection 38. The point of intersection 38 lies on the path of the stream of water when the water is discharged through the nozzle 24. Additionally, the point of intersection 38 is located at a distance from the discharge nozzle 24 which is the preferred distance between the nozzle 24 and the fire for the purposes of extinguishing the fire.

In operation, the water fire extinguisher 32 is used in a similar manner to the carbon dioxide extinguisher 10 shown in FIG. 1. In other words, before water is discharged from the extinguisher 32, the LED laser diodes 34, 35 are activated so that they direct their respective laser beams 36, 37 as shown in FIG. 3. The discharge nozzle 24 is moved (and the main body 32 may also be moved) so that the two dots corresponding to the laser beams 36, 37 are brought into coincidence at the target position. In other words, the discharge nozzle 24 is moved so that the laser beams 36, 37 cross at the desired target for the water. The handles 27 and 28 are then operated so that water is discharged through the discharge nozzle 24, the water being directed accurately at the position of the intersection point 38.

A second carbon dioxide fire extinguisher 39 is shown in FIG. 4. The main body 11, the valve 13, and the upper and lower handles 14, 15 are identical to the corresponding components of the first carbon dioxide extinguisher 10 shown in FIG. 1. These components are given the same reference numerals and are not described in detail. The second carbon dioxide fire extinguisher 39 also has a discharge horn 41 which differs from the discharge horn 12 shown in FIG. 1 in that the discharge horn 41 is positioned at a fixed angle relative to the main body 11.

The second carbon dioxide fire extinguisher 39 also has first and second LED laser diodes 42, 43 which are fixed directly to the main body 11. Again, as for the previous embodiments, the LED laser diodes 42, 43 are included in an electrical circuit (not shown) which also includes a push button switch (not shown) and a battery (not shown).

As seen in FIG. 4, the first and second LED laser diodes 42, 43 are aligned so that the laser beams 44, 45 which they generate and direct cross at an intersection point 46. This intersection point 46 lies on the axis of the conical discharge horn 41, at a distance from the end of the discharge horn 41 which corresponds to the desired distance of the discharge horn 41 from the fire.

The second carbon dioxide fire extinguisher 39 is used in a similar manner to the first carbon dioxide extinguisher 10.

It will be appreciated that in the second carbon dioxide fire extinguisher 39, because the position of the discharge horn 41 is fixed relative to the main body 11, the point of intersection 46 will always be in the desired position relative to the discharge horn 41.

In the fire extinguishers 10, 22, 32 shown in FIGS. 1 to 3, the LED laser diodes 17, 18, 29, 34, 35 are mounted in a fixed spatial relationship relative to the discharge members (the discharge horn 12 in FIG. 1, and the discharge nozzles 24 in FIGS. 2 and 3), so that the LED laser diodes remain correctly aligned relative to the discharge members 12, 24 even when the discharge members 12, 24 are moved relative to the main bodies 11, 23.

Where there are two LED laser diodes, then the two LED laser diodes should preferably be mounted sufficiently far from one another so that the angle between the laser beams is sufficiently great so as to allow the intersection point to be readily ascertained visually. For example, when the desired distance from the discharge member to the fire is about 12 feet (3.66 m), then the laser diodes are preferably at least 6 inches (15.2 cm) apart and more preferably at least 12 inches (30.5 cm) apart. A spacing of 6 inches (15.2 cm) between the laser diodes gives a light beam dot spacing of about 0.5 inches (1.27 cm) for each foot (30.5 cm) difference between the desired 12 feet distance and the actual distance. A spacing of 12 inches (30.5 cm) between the laser diodes gives a light beam spot spacing of about 1 inch (2.35 cm) for each foot (30.5 cm) difference between the desired 12 foot distance and the actual distance. If the discharge member is fixed relative to the main body, then the desired spacing between the diodes can generally be achieved by mounting the laser diodes on the main body, as in the case of the second carbon dioxide extinguisher 39 shown in FIG. 4. More normally, however, the discharge member is movable relative to the main body. In this case, although it is desirable to mount the LED laser diodes in a fixed spacial relationship to the discharge member, the discharge member may not itself be sufficiently wide so as to allow the desired spacing of the diodes if the diodes are mounted directly on the discharge member. This problem can be solved by using a bracket or the like which allows the desired spacing to be achieved, as shown in the extinguisher 10, 32 of FIGS. 1 and 3. Another possibility, in cases where the discharge member moves relative to the main body, is to mount the diodes with the desired spacing on the main body and provide means to ensure that the discharge member is located in the correct alignment relative to the laser diodes during use. For example a movable horn for a carbon dioxide extinguisher could be provided with a stop to stop pivotal movement of the horn relative to the main body at the correct position of the horn relative to the laser diodes.

It will be appreciated that the invention may be adapted in many other ways. For example, the invention is not limited to water and carbon dioxide fire extinguishers. It may be applied to any type of fire extinguisher having a discharge member for directing an extinguishing agent from the extinguisher towards a target. For example, the fire extinguisher may be of the dry chemical, vaporising liquid or foam varieties.

Instead of LED laser diodes, any suitable type of light source producing a light beam may be used. In cases where there are two light beams, it is not be necessary to have two light sources. For example a single laser beam generator may be used, with two fibre optic cables being used to direct two beams from the generator in different directions. Alternatively, a single light source may be split into two light beams using a beam splitter or half silvered mirror.

The mounting brackets 16, 30 and 33 need not be as described above and may take any suitable form.

Although the invention is described with reference to hand held fire extinguishers, the extinguisher of the invention need not be hand held. In this case, the discharge member will preferably be movable relative to the body holding the extinguishing agent. Examples of non-hand held fire extinguishers to which the current invention may be applied are wheeled units and fire fighting hoses.

1. A fire extinguisher having a discharge member for directing an extinguishing agent from the extinguisher towards a target, the extinguisher also having two light beam directors for directing respective light beams in respective predetermined directions relative to the discharge member so that the light beams substantially cross one another and so that the discharge member can be aimed at a target and positioned at a desired distance from the target by moving the discharge member so that the light beams substantially cross one another at or adjacent to the target.

2. An extinguisher according to claim 1, wherein each light beam director is a light source.

3. An extinguisher according to claim 2, wherein each light source is an LED laser diode.

4. An extinguisher according to claim 1, wherein the extinguisher has a main body holding the extinguishing agent, and the discharge member is movable relative to the main body, each light beam director being mounted in fixed spatial relationship relative to the discharge member.

5. A extinguisher according to claim 4, wherein the discharge member is provided with a bracket on which are mounted said two light beam directors in spaced relationship to one another.

6. An extinguisher according to claim 1, which is a hand held fire extinguisher.
